(19) United States
(12) Patent Application Publication
(10) Pub. No.: US 2008/0187686 A1
(43) Pub. Date: Aug. 7, 2008

(54) Method and Device For Fining and Homogenizing Glass and Products Obtained With the Aid of Said Method

(75) Inventors: Ramon Rodriguez Cuartas, Aviles (ES); Luis Grijalba Goicoechea, Aviles (ES); Pierre JeanVoine, Poissy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/597,524

(22) PCT Filed: May 24, 2005
(86) PCT No.: PCT/FR2005/050354

§ 371 Date: Aug. 24, 2007

(30) Foreign Application Priority Data
May 27, 2004 (FR) 0451047

(51) Int. Cl. C03B 5/225; C03B 7/092; B32B 17/00; C03B 7/094

(52) U.S. Cl. 428/1.1; 65/180; 65/134.2; 65/66; 428/409; 428/156

(57) ABSTRACT

The invention relates to a device capable of rotating about an axis (6), for the refining and homogenization of glass, comprising a receptacle (1) intended to receive the molten glass to be treated, a vacuum compartment (2) and at least one glass outlet orifice (5, 19), furthermore including a conveying means (7, 8, 17, 18) for conveying the molten glass from the feed receptacle (1) to the vacuum compartment (2).

It also relates to a process for manufacturing substrates employing the device according to the invention, and to the substrates thus manufactured.

The invention relates to a process for manufacturing glass, and especially flat glass, and to a device for implementing such a process.

The invention relates more precisely to a novel process for refining and homogenizing molten glass, in particular a rotary refining process under reduced pressure. The subject of the invention is also novel glass substrates that can be manufactured by such a process.

The quality of glass is a major preoccupation of glass manufacturers, especially flat glass. This quality, which may be expressed by an absence of gaseous and solid inclusions (refractories and unmelted or poorly melted batch materials), by perfect chemical homogeneity and by a perfect surface finish (low non-planarity and low roughness, in particular microroughness, as defined below), is especially required for applications in the automobile industry, and even more so for applications of the glass in the electronics field. Among the latter applications, the glass substrates for liquid-crystal displays (LCDs) must meet an extremely rigorous specification, especially in terms of roughness. In this field, poor glass quality, in particular poor homogeneity, the presence of gaseous and/or solid inclusions and excessively high roughness, is prejudicial to correct operation of the displays. In the complete glass manufacturing process, the melting, refining, homogenizing and forming steps each play their role in combination with one another, and the choice of the combination allowing better quality therefore proves to be of paramount importance. The manufacturers of substrates for displays, especially LCDs, have thus attempted to obtain sufficient quality by employing particular refining processes, specific forming processes of low capacity, such as what is called the “fusion-draw” process by drawing downwards, or by adding lengthy and expensive polishing steps, intended to reduce the microroughness of the glass produced by the “float” forming process. The increase in homogeneity is also obtained by reducing the manufacturing speeds. However, the current processes, which combine all or some of these means, remain insufficient in terms of quality or are incapable of reconciling quality with a high yield and a low manufacturing cost.

In the various steps for manufacturing the glass, the refining step is a fundamental step, in particular in the field of flat glass, and more particularly when it is intended for an application in the electronics field. This operation consists in removing as many as possible of the gaseous inclusions of various sizes, called “blisters”, bubbles or “seeds”, the presence of which in the final product is often restrictively controlled and sometimes prohibited. Thus, the quality requirements in terms of refining are themselves very strict for motor vehicle applications (especially for windscreens, which must ensure perfect visibility) and even stricter for applications of flat glass in the electronics field, especially a substrate for flat displays such as liquid crystal displays (LCDs), the presence of gaseous inclusions in which then being able to disturb the electrical operation and/or deform certain pixels making up the image.

These gaseous inclusions are of various origins. They come mainly from the air trapped between the particles of pulverant materials and from the outgassing due to certain chemical reactions that take place during the glass melting step. Carbonate-containing batch materials (such as for example sodium carbonate, limestone and dolomite) therefore release large quantities of carbon dioxide in gaseous form. The gaseous inclusions may also be due to reactions in which certain gases dissolve under certain conditions, or due to chemical or electrochemical reactions between the molten glass and certain materials present in the furnaces (refractory ceramics and/or metals). The gaseous inclusions are trapped within the mass of molten glass, from which they can escape at a rate proportional to the square of their diameter. Small bubbles (sometimes called “seeds”) therefore can escape only at extremely low rates. The rate of rise of bubbles may furthermore be slowed down by the viscosity of the glass and by convective movements that may entrain the bubbles toward the floor of the furnace.

The various refining processes that exist all have the common characteristic of trying to increase the rate of movement of the bubbles in the glass and/or of reducing the height of glass so as to shorten the path of the bubbles towards the atmosphere of the furnace.

Usually a chemical refining operation is carried out: a chemical compound injected into the batch materials produces an intense evolution of gas, the large bubbles thus formed coalescing with the small bubbles and carrying them away more rapidly to the surface. However, the chemical compounds commonly used are toxic and/or liable to emit gases that are prejudicial to the environment and/or incompatible with the forming process. The same applies to arsenic oxide and antimony oxide that are sometimes used in conjunction with nitrates (which are sources of polluting gases of the NOₓ type), sodium chloride (which gives off HCl) or sodium sulphate (which gives off sulphur oxides).

Physical refining processes, which are less polluting, have thus been proposed. In certain cases, a refining operation may be carried out heating the glass to a high temperature in order to reduce the viscosity of the molten glass and thus make it easier for the bubbles to rise in the glass bath. However, this process cannot be carried out on most glasses as it would involve extremely high temperatures and/or it would entail a very great increase in energy consumption. Processes involving a reduced pressure step have also been described. A partial vacuum makes it possible, on the one hand, to increase the size of the bubbles and, on the other hand, to encourage the dissolved gases to come out of solution, which sometimes results in intense foaming that will contribute to the effect of increasing the volume of the bubbles. Patent Application WO 99/35099 thus presents two types of processes for refining under reduced pressure. One is a static process and the other a dynamic process, more particularly one in which the glass is made to rotate. By rotating the glass it is possible to implement a centrifugal refining process, in which a pressure gradient in a direction perpendicular to the rotation axis allows bubbles to be removed more rapidly. Such a centrifugal refining process, but with no vacuum applied, is also disclosed in the patent document FR 2 132 028.

Centrifugal refining under reduced pressure is a particularly effective process, but its implementation such as disclosed in the abovementioned document WO 99/35099 has proved to be difficult. In particular, the design of the rotary seal for sealing the device and having to withstand high temperatures and/or the corrosive action of the glass, is rather complicated. The use of the device described in FIG. 3 of document WO 99/35099 allows the glass to be rotated under a partial vacuum, the glass then being returned to atmospheric pressure while still being pressed against the internal walls of the lower portion of the rotating device. This thin-film configuration, which is appreciated for improving the refining operation, does not, however, help to obtain good homogeneity of the glass.

The object of the present invention is to propose an improved device that alleviates the abovementioned drawbacks and a process for using this device, making it possible to produce excellent glass, both from the standpoint of refining and homogeneity.

The subject of the invention is a device capable of rotating about an axis, for the refining and homogenization of glass, comprising a receptacle intended to receive the molten glass to be treated, a vacuum compartment and at least one glass outlet orifice, and also a conveying means for conveying the molten glass from the feed receptacle to the vacuum compartment.

This device comprises a series of different elements, which are capable of rotating and are fastened to one another: a receptacle intended to receive the molten glass to be treated, a vacuum compartment and at least one glass outlet orifice.

The invention thus defined has the advantage when it is implemented, of performing the molten glass feed operation and the operation of placing the said molten glass under a partial vacuum in different compartments of the device, thus simplifying the design of the rotary seal without affecting the refining performance.

The elements that make up the device according to the invention preferably have a geometry that is cylindrical about the rotation axis of the device, it being advantageous for the axis to be substantially vertical.

The feed receptacle preferably has a larger diameter than a diameter of the vacuum compartment. It is preferably in the form of a spinner bowl. According to a first embodiment, the feed receptacle is located at a lower height than the height of the vacuum compartment. According to a second embodiment, preferred for reasons of simplicity of operation, it is located above the said compartment.

The device according to the invention also includes a means of conveying the molten glass from the feed receptacle to the vacuum compartment. In the embodiment in which the feed receptacle is located at a lower height than the height of the vacuum compartment, this means is advantageously formed by at least one radial tube, which joins the rotation axis of the device, and then by an axial tube, which joins the vacuum compartment at its lower end. In the embodiment in which the feed receptacle is located above the vacuum compartment, the conveying means is preferably formed by at least one radial tube, which joins the vacuum compartment to at least that one of its upper ends which is furthest away from the rotation axis. The various tubes employed are advantageously made of platinum, either pure platinum or platinum that is alloyed in particular with rhodium in order to improve its mechanical strength.

The device according to the invention preferably includes a lower zone or cavity, preferably cylindrical, located beneath the vacuum compartment and at the lower end of which zone or cavity the or each glass outlet orifice is located. This lower cavity is intended to be filled with rotating molten glass.

The or each glass outflow or outlet orifice is preferably at the lower end of the device, either on or in the immediate vicinity of the rotation axis, or at a non-zero distance from the said axis.

A preferred embodiment of the device according to the invention consists, for reasons of simplicity of operation, of a device in which the feed receptacle is located above the vacuum compartment, the glass outlet orifice being located on or in the immediate vicinity of the rotation axis.

The constituent materials of the device according to the invention are chosen so as to be able to withstand the high temperatures and the high pressures. The outer shell of the device is advantageously made of refractory steel. The internal surface, in contact with the glass, is preferably formed by a platinum lining or by refractory ceramics covered with a thin coating of platinum. A layer of insulating material resistant to high temperatures is inserted between the steel shell and the platinum-coated internal lining. The platinum lining is preferably held mechanically in place thanks to a vacuum created between the refractory steel shell and the said lining. The seal is then produced by methods well known to those skilled in the art, by welding between the said lining and the steel shell, covered beforehand with layers of platinum and of intermediate oxides intended to solve the problems of differential expansion. The term “platinum” should be understood here to mean both pure platinum and platinum alloyed for example with rhodium.

Electrical resistors are advantageously placed in the insulation so as to be able to heat the device. The need for heating may make itself felt at start-up of the device, or for heating a glass that is too viscous.

The object of the invention is also a glass refining and homogenizing process employing the device according to the invention. This process comprises a step of feeding molten glass into a receptacle of a device capable of rotating about an axis followed by a step of conveying the said glass to a compartment of the said device, in which compartment the said glass is subjected to a subatmospheric pressure.

The molten glass feed preferably takes place away from the rotation axis of the device. Thus, the rotation, feed and vacuum functions are physically decoupled.

The molten glass is fed into the receptacle of the rotatable device preferably at substantially atmospheric pressure. Since the said receptacle rotates integrally with the device to which it belongs, the molten glass is thus subjected to a first of centrifugal refining under substantially atmospheric pressure suitable for participating in the glass refining process and improving the said glass.

According to a first embodiment, the molten glass feed takes place at a height above the total height of the device, the molten glass then being conveyed under weight and sucked into the vacuum compartment. This embodiment corresponds to the case in which the device has a feed receptacle located above the vacuum compartment.

According to an alternative embodiment, it may be advantageous for the molten glass feed to be carried out at a height below the total height of the device, for example substantially at mid-height of the device, or else at a height below the height of the compartment where the glass is under vacuum. In this case, the glass is then conveyed only by suction into the reduced pressure compartment. As an advantage of such an embodiment, it makes it possible, where appropriate, to adapt the device to the configuration of existing melting furnaces. For example, when the device for implementing the process according to the invention has to be sized so that it is of great height, such a feed mode means that the glass melting furnace does not have to be overly raised or the said device does not have to buried.

The step of conveying the molten glass to the vacuum compartment takes place by weight and/or suction, preferably via one or more tubes, for example made of heat-resistant metal inert with respect to the molten glass, such as pure platinum or platinum alloyed for example with rhodium in order to improve its mechanical properties.

When the conveying takes place only by suction, the glass is preferably conveyed towards the rotation axis of the device, via one or more horizontal radial tubes, and then sucked up by means of an axial tube located on the said rotation axis in order to reach the vacuum compartment. The dimensions of the device and the operating parameters of the process are then adjusted so that the molten glass is actually sucked up. This is because the glass, while it is being conveyed towards the axial tube, is subjected to centrifugal forces that oppose the suction forces. The rotation speed of the device and the pressure difference between the vacuum compartment and the glass feed receptacle are thus adapted so that the centrifugal forces do not prevent the molten glass from being actually conveyed into the said vacuum compartment.

The molten glass injected into the vacuum compartment is subjected to the combined action of the reduced pressure and the rotation. The rotation has the effect of creating a free glass surface of substantially paraboloidal shape.

The said combined action allows the refining effectiveness to be considerably increased, which effectiveness may be expressed in two ways, either in terms of a reduction in the number of gaseous inclusions for the same output (the output being the quantity of glass treated per unit time) or in terms of an increase in output for the same number of residual gaseous inclusions.

The combination of centrifugal refining and a vacuum makes it possible to obtain the following effects, that increase the effectiveness: the vacuum firstly allows the size of the existing bubbles to be increased (the volume of gas being inversely proportional to pressure according to the perfect gas law), and therefore their rate of displacement. The vacuum then causes a massive and sudden generation of gas by the gas previously dissolved in the glass physically coming out of solution. It has in particular been observed that the water and sulphate content of the glass having undergone this refining step becomes zero or almost zero, thereby preventing any inopportune rebubbling by coming out of solution on contact with materials such as platinum throughout the rest of the glass manufacturing process. These newly created bubbles then coalesce with the expanded bubbles to create new bubbles, the large size of which allows greater mobility in the molten glass. It has been observed that the coalescence of the bubbles is particularly accelerated by the rotation, according to an effect that we may term a “dynamic coalescence” effect. Since these bubbles are subjected to rotation, they move axially towards the free (paraboloidal) surface of the glass in order to be drawn towards the outside of the glass. It has been observed that the implementation of this step of the process allowed all the “small” bubbles, that is to say the bubbles with a diameter of less than about 0.5 to 1 mm, to be eliminated. The shear caused by the rotation furthermore prevents foam from forming. This is because gas generation during the vacuum step consequently leads to the formation of a foam, which may prove to be prejudicial to proper operation of the process owing to the large volume that it may occupy. The elimination of this foam within the context of the process according to the invention therefore proves to be particularly appreciated. Finally, the application of a vacuum to the glass, owing to its effect of causing the gases dissolved in the glass to come out of solution, makes it possible to considerably increase the level of homogeneity of the glass. This generation of gas bubbles within the mass of glass in fact creates an extremely effective micro-agitation.

The residence time of the glass in the vacuum compartment is short, of the order of a few seconds, especially less than 30 seconds, and even less than 15 seconds. The total residence time of the glass in the refining device is of the order of a few minutes, generally less than 10 minutes, even less than 5 minutes, especially less than 1 minute, and even less than 30 seconds. This residence time is preferably greater than 5 seconds so as to ensure sufficient refining quality. Despite this very short time, the quality of the refining obtained is equivalent or better than that obtained by conventional chemical refining processes or static reduced-pressure refining processes. For the same refining quality, the total residence time of the glass in the refining device is shorter than the residence time of the glass in a conventional chemical or static reduced-pressure refining process. Such a process thus has the advantage of being able to reconcile a small size of the device for a high output. A second advantage stemming from the short residence time, especially in the vacuum compartment, is that there is less fly-off of volatile compounds such as for example boron oxide or alkali metal oxides, and therefore better control of the chemical composition of the glass, and consequently of its properties. The short residence time is also very uniform, or in other words the distribution of the residence times is narrow, resulting in excellent chemical homogeneity of the glass.

Furthermore, several features of the process according to the invention allow a very low pressure to be used. First of all, the vacuum is limited to one compartment of the device and not to the device in its entirety. Moreover, the glass feed and reduced-pressure steps are not simultaneous, which means, since the process is continuous, that the glass feed does not take place directly in the vacuum compartment. It is therefore possible to use a rotary steel that is standard for a person skilled in the art in order to seal the vacuum compartment, the sealing being of much better quality than that which can be obtained by the process described previously in the abovementioned application WO 99/35099. The process according to the invention thus makes it possible to achieve pressures of lower than 400 millibars, especially lower than 200 millibars or 150 millibars, and even lower than 50 millibars. The pressure within the vacuum compartment is preferably within the 50-150 millibar range. The possibility of achieving very low pressures helps to improve the refining quality for the same output, or to increase the output for an equivalent refining quality, or else to reduce the treatment temperatures. In general, the effect of reducing the pressure within the vacuum compartment by a given factor is to increase the output by the same factor. The low pressures obtained also help to achieve a high level of homogeneity of the glass by the micro-agitation effect due to the gas bubbles that form in the mass of molten glass, the number of bubbles being greater the lower the pressure.

Another feature of the process described in the application WO 99/35099 is indeed prejudicial to achieving a low pressure in the vacuum compartment. This is the fact that there is atmospheric pressure in the rotary refiner directly after the glass has passed through the vacuum compartment, thus two compartments at different pressures coexist, with the risks of leakage that this situation engenders.

Within the context of the present invention, the molten glass is preferably returned to substantially atmospheric pressure under the effect of its own weight, which effect is optionally coupled with a centrifugal force effect, the glass then flowing out of the rotatable device towards a forming step. This step of the process is carried out in the lower zone or cavity, preferably a cylindrical cavity, located beneath the vacuum compartment, the or each glass outlet orifice being located at the lower end of the said zone or cavity. Within the context of this preferred embodiment, this lower cavity is filled with rotating molten glass, which contributes, via the shear movements generated, to a spectacular increase in the uniformity of the glass. This step of the process also preferably corresponds to a thermal conditioning step carried out on the glass before forming, that is to say to a step during which the glass is progressively heated within the device according to the invention to a uniform temperature corresponding to the forming temperature. The glass may then be directly formed without passing through feeders of the forming means. The advantage of this embodiment lies in the fact that any fly-off of volatile materials, such as boron oxide, is avoided, thereby helping to increase the homogeneity of the glass paste and the microroughness of the final glass substrate. This is because the inventors have observed that the surface modifications of the chemical composition of the glass before the forming step would cause an increase in the microroughness of the glass substrate produced.

The outflow of molten glass from the rotatable device preferably takes place via one or more outflow orifices located at the lower end of the rotatable device. This takes place only when the pressure of the molten glass is at atmospheric pressure or higher. If this is not the case, the glass cannot flow out, and there is a risk on the contrary of air getting into the rotary device via the outflow orifices, thus creating undesirable gaseous inclusions.

In a first embodiment, the molten glass flows out via an outflow orifice located on or in the immediate vicinity of the rotation axis of the rotatable device. In this case, the molten glass is put back to substantially atmospheric pressure only by the effect of its own weight. However, this embodiment does have a drawback: owing to the density of the glass, which is around 2.5 g/cm³, the height of the device must be approximately 4 metres.

The inventors have therefore developed a second embodiment, in which the molten glass flows out via at least one outflow orifice located at a non-zero distance from the rotation axis of the rotatable device. Thus, the glass flowing out of the device is subjected not only to the pressure resulting from the height of the glass located above it, but also to the pressure resulting from the rotation, which is proportional to the square of the product of the angular velocity of rotation multiplied by the distance of the glass from the rotation axis. By increasing the distance between the axis and the outlet orifice and increasing the angular velocity of rotation it is then possible to significantly reduce the height of the device. However, it does make the practical construction of the device more complex. Furthermore, the glass flowing out away from the axis is subjected to a tangential linear velocity equal to the product of the distance between the axis and the outlet orifice multiplied by the angular velocity of rotation. If this velocity is too high, it has been observed that new gaseous inclusions are created by the incorporation of air when the glass jet encounters the glass bath conveyed towards the forming step.

The rotation speed of the device for implementing the process according to the invention is preferably between 150 and 500 revolutions per minute. Below 150 revolutions per minute, the refining and homogenizing effectiveness is often insufficient. The rotation plays a homogenizing role up to the step of outputting the glass from the rotating device. This is because it has been observed that the shear stresses experienced by the glass owing to the rotation considerably increase the chemical homogeneity of the glass, much more effectively than the homogenization that can be achieved by means of mechanical agitators, sometimes called stirrers. Furthermore, a beneficial effect on the refining is also observed because of these very shear stresses, being manifested by a fragmentation of the bubbles still present as a multitude of small invisible bubbles or bubbles that are easily able to be resorbed into the glass. Above 500 revolutions per minute, the feasibility on an industrial scale is however compromised. For the abovementioned reasons of too high a glass output linear speed in the case in which the molten glass flows via orifices located away from the rotation axis, the rotation speed is even preferably less than 200 revolutions per minute and advantageously between 160 and 180 revolutions per minute.

The mean temperature to which the glass is exposed during the refining and homogenizing process according to the invention is preferably between 1 250 and 1 650° C., preferably between 1 300 and 1 500° C. and advantageously between 1 300 and 1 400° C., in particular for a soda-lime-silica glass, which often requires temperatures of around 1 500° C. when it has to be refined in a conventional manner. For an aluminoboro-silicate glass containing no alkali metals, such as that used for electronic applications (especially substrates for LCD displays), and usually refined at above 1 600° C., the refining temperature according to the process of the present invention is preferably between 1 400° C. and 1 550° C. In general it is preferable, strictly from the energy standpoint, to refine the glass at temperatures as low as possible. The process according to the invention does in fact allow the refining temperatures to be reduced compared with chemical refining processes. The glass is therefore preferably not subjected to any reheating operation during implementation of the process according to the invention.

The subject of the invention is also a glass manufacturing process that includes a refining and homogenizing step according to the invention. This manufacturing process comprises a glass melting step, a refining and homogenizing step and then a forming step.

The glass subjected to the various steps of the process according to the invention comes from a prior melting step. The term “melting” should be understood to mean the step used for converting, thanks to the effect of temperature, a mix of generally pulverant batch materials into a mass of liquid glass. This melting step is preferably carried out at a temperature not greatly above the refining temperature, especially not more than 50° C. above, or even at, the refining temperature. This melting operation may be carried out using glass furnaces provided with overhead burners that heat the mass of glass by radiation and/or with electrodes submerged in the glass, which heat the mass of glass by Joule heating. It is preferably carried out using a furnace having one or more submerged burners for several reasons, which will be explained in detail below. Within the context of the invention, the term “submerged burners” is understood to mean burners configured in such a way that the “flames” that they generate or the combustion gases emanating from these flames develop within the very mass of materials undergoing conversion. In general, the burners are placed so as to be flush with or to extend slightly beyond the side walls or the floor of the reactor used. The operating principle of a furnace with submerged burners for melting glass is already known, and has in particular been described in the patents WO 99/35099 and WO 99/37591: it consists in causing combustion directly within the mass of vitrifiable materials to be melted, by injecting the fuel (in general gas of the natural gas type or hydrogen) and the oxidizer (in general air or oxygen) via burners placed below the level of the molten mass, and therefore within the glass bath. This type of submerged combustion causes intense convective stirring of the materials being melted, thereby making the melting process rapid. Such a melting process is particularly suited to the refining process according to the invention as the intense convective stirring allows the use of temperatures significantly lower than those employed in conventional processes. Since the process according to the invention is itself carried out at low temperature, there is thus no need for a molten glass cooling step before the glass is injected into the rotational refining device. Furthermore, it has been observed that a melting step carried out at low temperature generates a larger amount of gas dissolved within the mass of glass, thereby further increasing the pressure needed to physically make the gases come out of solution, this being identified as one of the origins of the effectiveness of the process according to the invention. Glass melted at low temperature therefore has the advantage of not requiring too low a pressure while the glass is passing through the vacuum compartment in order to ensure that the gas comes out of solution effectively. The glass may also be advantageously melted by a melting process employing submerged electrodes, the said process also allowing melting at relatively low temperatures.

The molten glass, refined and homogenized by the process according to the invention, may then be conveyed via feeders to the forming device employed, for forming flat glass, holloware or fibres. However, as indicated above, it is clearly preferable for the forming device to be fed directly at the outlet of the refining and homogenizing device according to the invention, without any feeder for conveying the glass to the forming step. The glass manufacturing process according to the invention therefore preferably includes no feeder, avoiding any fly-off of volatile materials prejudicial to the homogeneity of the glass and to the production of a substrate having a very low microroughness.

The very high homogeneity obtained by the refining and homogenizing process according to the invention makes it possible to dispense with the use of agitators, sometimes called stirrers, throughout the manufacturing process.

The forming of flat glass may consist, for example, of a floating step, in which the glass floats on molten tin using the float process, a drawing step, using the Fourcault or Pittsburgh processes, these being well known to those skilled in the art, a rolling step using casting rollers, or else a forming step using downward extension and drawing of the “down-draw” or “fusion-draw” type. The forming of fibres may be carried out by a process in which streams of molten glass are mechanically attenuated, the said streams flowing out of orifices based in the base of a bushing heated by Joule heating, or an “internal” centrifugal process making use of spinners rotating at high speed, the said spinners being perforated with orifices, followed by a fibre attenuation step by the injection of hot gas.

Within the context of forming using the float process, it has proved to be particularly advantageous, again for the sake of improving the surface quality of the glass, to use a float installation in which the floated molten glass has no stationary points, the velocity of the glass being zero at none of its points, so as to prevent devitrification (i.e. the nucleation and growth of crystals from the mass of glass). In particular, molten metal, generally tin, is injected into the installation so that it constitutes a moving reception zone for the molten glass. It is preferably injected at those float points in the glass that would have been stationary points in the absence of injection. Floating the glass on a moving bath of molten tin, the said bath being taken off downstream of the float installation and then reinjected at least upstream after possibly reheating it, thus prevents the presence of stagnant glass points that could cause solid inclusions to grow.

The process according to the invention is suitable for the refining and homogenizing of glass having a very great variety of compositions. All the compositions presented below are expressed in percentages by weight.

These glass compositions may be of the soda-lime-silica type. The term “soda-lime-silica” is used here within the broad sense and relates to any glass composition consisting of a glass matrix comprising the following constituents (in percentages by weight):

| | |
|---|---|
| SiO₂ | 64-75% |
| Al₂O₃ | 0-5% |
| B₂O₃ | 0-5% |
| CaO | 5-15% |
| MgO | 0-10% |
| Na₂O | 10-18% |
| K₂O | 0-5% |
| BaO | 0-5%. |

Apart from these standard glasses of the soda-lime-silica type, the process according to the invention is particularly beneficial for the manufacture of various types of special glasses:
glasses that have a low Na₂O content and a relatively high content of alkaline-earth oxides, especially CaO, this being advantageous from the economic standpoint in terms of the cost of batch materials, but are rather corrosive at the conventional melting temperatures and relatively hard to melt by conventional processes. These may for example be the glass compositions described in Patent FR 2 765 569, comprising the following amounts of oxides (expressed in percentages by weight):

| | |
|---|---|
| SiO₂ | 72-74.3% |
| Al₂O₃ | 0-1.6% |
| Na₂O | 11.1-13.3% |
| K₂O | 0-1.5% |
| CaO | 7.5-10% |
| MgO | 3.5-4.5% |
| Fe₂O₃ | 0.1-1% |

or else compositions of the type (expressed in percentages by weight):

| | |
|---|---|
| SiO₂ | 66-72%, especially 68-70% |
| Al₂O₃ | 0-2% |
| Fe₂O₃ | 0-1% |
| CaO | 15-22% |
| MgO | 0-6, especially 3-6% |
| Na₂O | 4-9, especially 5-6% |
| K₂O | 0-2, especially 0-1% |
| SO₃ | traces; |

glasses having a high silica content, these being advantageous from the economic standpoint, and with a relatively low density, the composition ranges of which, again expressed in percentages by weight, are the following:

| | |
|---|---|
| SiO₂ | 72 to 80% |
| CaO + MgO + BaO | 0.3 to 14% |
| Na₂O | 11 to 17% |
| Alkali metal oxides | 11 to 18.5% |
| Al₂O₃ | 0.2 to 2% |
| B₂O₃ | 0 to 2% |
| Fe₂O₃ | 0 to 3% |
| SO₃ | possible traces |
| coke | 0-600 ppm |

and optionally colouring oxides, such as oxides of Ni, Cr, Co, etc.

Given the little fly-off of volatile materials that the process according to the invention occasions, it is especially suitable for glasses containing boron. Because of its capability of refining and homogenizing viscous glasses (at lower temperature), it is also suitable for glasses with a zero or almost zero content of alkali metal oxides, especially with a view to applications as reinforcement fibres or for fire-resistant glazing or else for substrates used in the electronics industry. Within the context of the glass being used as substrate for liquid crystal displays (LCDs), particularly suitable compositions comprise the following elements:

| | |
|---|---|
| SiO₂ | 58-76% |
| B₂O₃ | 3-18%, especially 5-16% |
| Al₂O₃ | 4-22% |
| MgO | 0-8% |
| CaO | 1-12% |
| SrO | 0-5% |
| BaO | 0-3% |

and more particularly:

| | |
|---|---|
| SiO₂ | 58-70% |
| B₂O₃ | 3-15% |
| Al₂O₃ | 12-22%, especially 10-20% |
| MgO | 0-8%, especially 0-2% |
| CaO | 2-12%, especially 4-12% |
| SrO | 0-3% |
| BaO | <0.5%. |

These compositions have expansion coefficients of less than 35×10⁻⁷° C.⁻¹ and a strain point above 650° C. The glass Eagle 2000® sold by Corning Inc. is an example of this family of glasses.

A preferred glass is formed by the following composition ranges:

| | |
|---|---|
| SiO₂ | 60-70% |
| B₂O₃ | 6-13%, especially 11-13% |
| Al₂O₃ | 13-16%, especially close to 14% |
| MgO | 0-2%, especially close to 0 |
| CaO | 7-12%, especially 7-9% |
| SrO + BaO | 0-1%, especially close to 0. |

Among glasses containing boron, glasses possessing low expansion coefficients and glasses useful for applications as fire-resistant glazing, the glasses with the following compositions are particularly suitable to be refined and homogenized using the process according to the invention:

| | |
|---|---|
| SiO₂ | 78-86% |
| B₂O₃ | 8-15% |
| Al₂O₃ | 0.9-5% |
| MgO | 0-2% |
| CaO | 0-1.5% |
| Na₂O | 0-3% |
| K₂O | 0-7%. |

An example of this type of composition is the glass Pyrek® sold by Corning Inc.

Among the other volatile species are lithium and zinc, which appear in glass compositions capable of undergoing a controlled crystallization treatment in order to produce glass-ceramics with an expansion coefficient close to 0, especially those suitable for being used as hobs. Some of these compositions comprise the following oxides, in the following contents expressed in percentages by weight:

| | |
|---|---|
| SiO₂ | 62-70% |
| Al₂O₃ | 17-25% |
| Li₂O | 2-4% |
| MgO | 0-2% |
| ZnO | 0-2% |
| TiO₂ | 2-6% |
| ZrO₂ | 0-3%. |

It is customary for most of the special glasses mentioned above to be refined chemically, using arsenic or antimony (in the case of glass for glass-ceramics and glass for LCD display substrates) or using chlorine, or even using a sulphate. By employing the refining process according to the invention it is possible to dispense with the use of such chemical compounds harmful to the environment, while still obtaining excellent refining quality. Advantageously, the process according to the invention therefore makes it possible to obtain a glass containing no refining agents such as sulphates, arsenic, antimony, chlorine or tin, and advantageously the glass substrate thus produced contains no refining agents such as sulphates, arsenic, antimony, chlorine or tin.

Within the context of the glass being used as substrates for what are called “plasma” displays, particularly suitable compositions (expressed in percentages by weight) are:

| | |
|---|---|
| SiO₂ | 40 to 75% |
| Al₂O₃ | 0 to 12% |
| Na₂O | 0 to 9% |
| K₂O | 3.5 to 10% |
| MgO | 0 to 10% |
| CaO | 2 to 11% |
| SrO | 0 to 11% |
| BaO | 0 to 17% |
| ZrO₂ | 2 to 8%. |

The process according to the invention has proved to be especially suitable, through its implementation and for the reasons already mentioned above, for obtaining glasses having a particularly high degree of homogeneity and refining.

The subject of the invention is therefore also a glass substrate that can be obtained by the process according to the invention, this substrate being characterized by its homogeneity.

The degree of homogeneity of the glass may be expressed as the standard deviation of the refractive index, as measured by the Christiansen-Shelyubskii method. This method is described in the article “Application of the Christiansen-Shelyubskii method to determine homogeneity and refractive index of industrial glasses” by T. Tenzler and G. H. Frischat, Glastech. Ber. Glass Sci. Technol. 68 (1995) No. 12, pp. 381 to 388. This optical method uses, in the application of it made within the context of the present invention, glass specimens that are very carefully annealed so as to avoid any refractive index heterogeneity due to density differences and therefore not attributable to a chemical heterogeneity, and the particle size fraction of which studied varies from 315 to 355 microns. With the measurement conditions being thus specified, the use of the process according to the invention makes it possible to obtain glasses having an extremely small standard deviation of the refractive index, and especially less than 5×10⁻⁵ or even 2×10⁻⁵. The final substrate, but also the intermediate glass resulting from the refining and homogenizing step before the forming step, may have such low values.

The inventors have also discovered that the process according to the invention makes it possible, in particular using compositions capable of manufacturing LCD displays and such as those described above, to achieve a homogeneity such that the glass, undergoing a subsequent forming step by the float process, has a microroughness making it suitable to be used as the substrate for an LCD display, especially a microroughness of less than 20 nm or less than 15 nm or 10 nm, and even less than 4 nm.

The microroughness is defined by measuring the maximum peak-to-valley height on a 12 mm diameter specimen. Measurements may also be taken on 25 mm diameter specimens, the characteristic undulation wavelengths being between 1 and 25 mm. This measurement may be carried out by optical interferometry measurements or by measurements using mechanical feelers, these methods being well known to those skilled in the art. It has been discovered that the factors having a first-order effect on this quantity are the homogeneity of the glass and the forming process. Thus, glass having such microroughness is currently produced only by the “down-draw”process. Using known melting and homogenizing techniques, the float process has proved hitherto incapable of producing glass having such a property.

The subject of the invention is therefore also a glass substrate produced by the float process, and therefore having on one of its faces a tin-enriched surface layer, and having a microroughness of less than 20 nm, or less than 15 nm or 10 nm, and even less than 4 nm, preferably obtained without polishing. The process according to the invention, because of the refining and homogeneity quality that it generates, is also well suited to the manufacture of thin glass or even glass film, with a thickness of less than 1 millimetre or even less than 0.5 millimetres.

The process according to the invention is therefore perfectly able to be integrated into a process for manufacturing glass substrates for display systems, such as plasma displays, and more particularly to liquid crystal displays (LCDs) or organic light-emitting diode (OLED) displays, or in a process for manufacturing glass substrates for optical filters or diffusers.

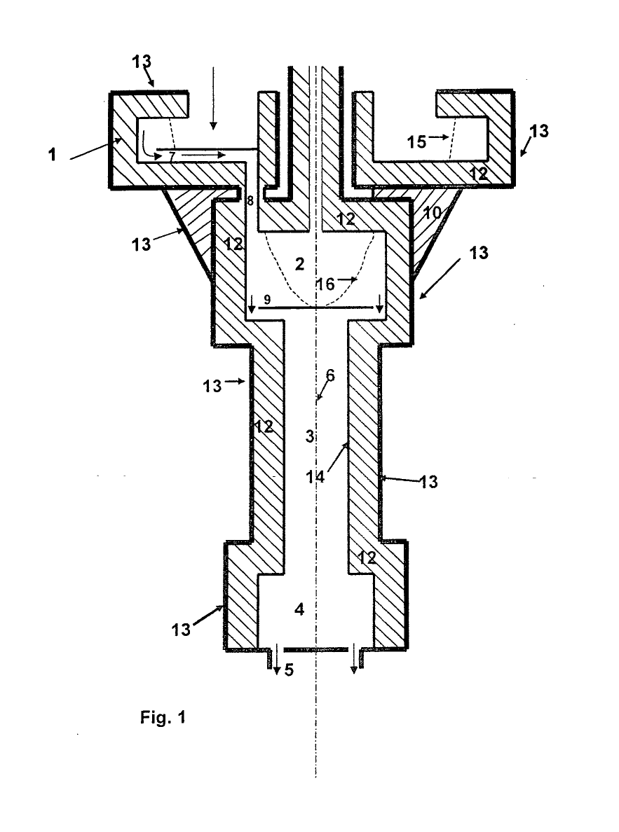

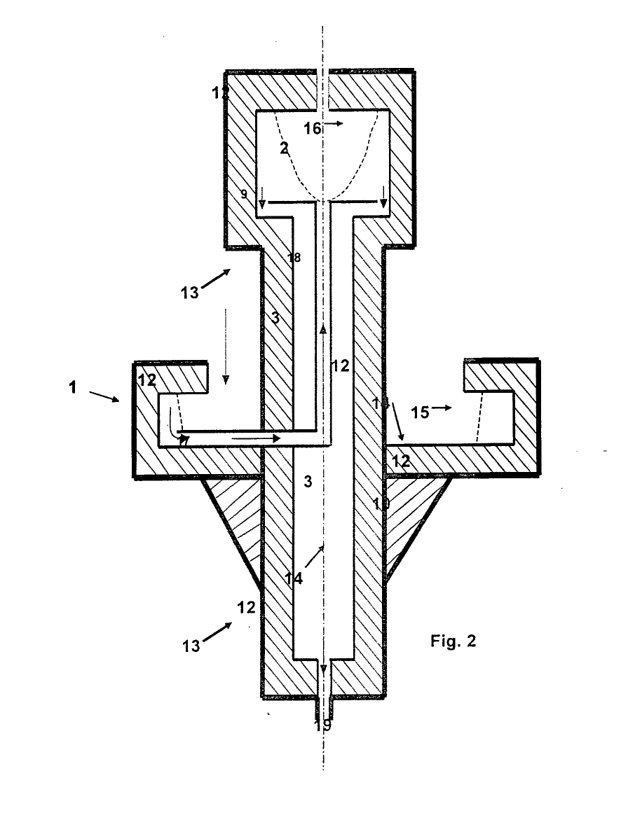

The present invention will be more clearly understood on reading the detailed description below of non-limiting embodiments illustrated by FIGS. 1 and 2.

FIG. 1 shows a vertical cross section of the device according to the invention in the embodiment in which the feed receptacle is located above the vacuum compartment.

The entire device, with a height of about 2.50 metres, can be rotated about the vertical axis 6 indicated by the dotted line, with respect to the axis of which it has a substantially cylindrical geometry. It consists of an external shell 13 made of refractory steel and internal lining 14 made of platinum, the inside diameter of which is 150 mm (diameters ranging from 50 to 300 mm are particularly suitable for the device according to the invention). The use of this device and the constituent features of said device may thus be described.

The unrefined molten glass, of the soda-lime-silica type, coming from a stop in which it is melted in a furnace comprising two submerged burners, feeds, at substantially atmospheric pressure and at a temperature of 1 400° C., and away from the rotation axis 6, the feed receptacle 1 connected to the body of the device by the refractory steel reinforcements 10. When rotated at an angular velocity of 170 revolutions per minute, the free surface of the glass assumes the form of a proportion of a paraboloid of revolution 15. The glass is then conveyed via a horizontal radial tube 7 made of platinum and then a vertical tube 8 to the vacuum compartment 2. The diameters of the tubes 7 and 8 are around 50 mm. The pressure within the compartment 2 is around 120 millibars. The free surface of the glass assumes the form of a portion of a paraboloid of revolution 16. Under the combined influence of the rotation and the vacuum, making use of the “dynamic coalescence” effect described above, the molten glass is refined at a temperature of about 1 350° C. and then conveyed to a cylindrical cavity 3 via two openings made in a platinum plate 9 placed over the bottom of the compartment 2. The rotating mass of glass fills the cylindrical cavities 3 and 4, the latter cavity being of larger diameter. The shear induced by the rotation helps to further improve the homogeneity of the glass. Two outlet orifices 5 having a diameter of 30 mm are placed at 40 mm from the rotation axis 6. Under the influence of the pressure resulting from the mass of molten glass and from the rotation, the glass flows out of the device at atmospheric pressure and at a temperature of 1 200° C. It then joins a feeder that conveys it to a forming step using the float process. However, it is preferable to form the glass directly on leaving the device according to the invention, without the glass passing through a feeder.

The total output is about 100 tons/day and the quality of the glass, both in terms of homogeneity and refining, is excellent. In particular, no bubble greater than 50 microns in diameter is observed on a plate of 1 m² area. The residence time of the glass in the device is about 2 minutes and the distribution of residence times is very narrow. The residence time in the vacuum compartment is of the order of a few seconds, hence insignificant losses of alkali metals. Furthermore, the absence of contact between the molten glass and refractory ceramics liable to contaminate it contributes to its high degree of homogeneity.

FIG. 2 shows a vertical cross section of the device according to the invention in the embodiment in which the feed receptacle is located at a height below that of the vacuum compartment.

The features of the device have the following differences from those of the device described in FIG. 1:
the feed receptacle 1 is located down below the vacuum compartment 2;
the glass is conveyed to the compartment 2 only by suction, via a horizontal radial tube 17 made of platinum and then a vertical axial tube that supports the platinum plate 9. In this embodiment, the plate 9 is therefore not supported by the bottom of the compartment 2; and
the glass flows out of the device via a single orifice 19 located on the rotation axis 6. Since the return to atmospheric pressure takes place only due to the weight of the glass, the total height of the device must be about 4 metres. Because of the large height of the device, the location of the receptacle 1 at about the mid-height of the overall device means that it is unnecessary to bury the said device or to overly raise the melting furnace.

This device serves to implement a process for manufacturing substrates for LCD displays in the following manner:

A glass with a composition of the aluminoborosilicate type containing no alkali metals (which is capable of manufacturing substrates for LCD displays as it gives the glass the properties of having a low expansion coefficient, especially less than 35×10⁻⁷° C.⁻¹ and a high strain point, especially above 650° C.) is melted in a furnace with overhead burners. Its composition is chosen from the family of compositions defined by the following components within the limits by weight below:

| | |
|---|---|
| SiO₂ | 58-70% |
| B₂O₃ | 3-15% |
| Al₂O₃ | 12-22% |
| MgO | 0-8% |
| CaO | 2-12% |
| SrO | 0-3% |
| BaO | 0-3%. |

The mass of molten glass feeds the refining and homogenizing device described and then undergoes, directly, a forming step via the float process, without the glass passing beforehand through a feeder. The glass sheets thus formed have a thickness of 0.5 mm and a microroughness of 3 nm, making them suitable to be used as a substrate for displays of the LCD type.

A preferred device may also be described by combining the embodiments of FIGS. 1 and 2, in this case the presence of a single orifice 19 located on the rotation axis 6 and a feed receptacle 1 located above the vacuum compartment 2.

Finally, within the context of the two embodiments described by way of example, we should emphasize that the operation of the device is noteworthy in that it is self-regulated. The device operates within a narrow output range, imposed by its dimensions, especially the diameter of the conveying tubes (7, 8, 17, 18), by the rotation speed and by the level of vacuum. This is because, if the glass level inside the device drops, the output pressure drops, thereby tending to reduce the output and therefore making the glass level rise again. Conversely, an increase in the glass level would have the effect of increasing the output pressure, and therefore an increase in the output, which will re-equilibrate the glass level to its prior value.

The device is started up under the control of a programme in which the rotation speed is increased as the pressure in the compartment 2 is reduced. It is thus possible to progressively increase the glass level in the device while still reducing the pressure.

The present invention has been described above merely by way of example. Of course, a person skilled in the art is capable of producing various alternative forms of the invention without thereby departing from the scope of the patent as defined in the claims.

1. Device capable of rotating about an axis, for the refining and homogenization of glass, comprising a feed receptacle intended to receive the molten glass to be treated, a vacuum compartment, at least one glass outlet orifice, and at least one conveying means for conveying the molten glass from the feed receptacle to the vacuum compartment.

2. Device according to claim 1, having a geometry that is cylindrical about the rotation axis.

3. Device according to claim 1, wherein the rotation axis is substantially vertical.

4. Device according to claim 1, wherein the feed receptacle has a greater diameter than the diameter of the vacuum compartment.

5. Device according to claim 1, wherein the conveying means for conveying the molten glass from the feed receptacle to the vacuum compartment is a tube made of platinum.

6. Device according to claim 1, wherein the feed receptacle is located at a lower height than the height of the vacuum compartment, the conveying means being formed by at least one radial tube, which joins the rotation axis, and by an axial tube, which joins the vacuum compartment at its lower end.

7. Device according to claim 1, wherein the feed receptacle is located above the vacuum compartment, the conveying means being formed by at least one radial tube, which joins the vacuum compartment to at least that one of its upper ends which is furthest away from the rotation axis.

8. Device according to claim 1, further comprising a lower zone or cavity located beneath the vacuum compartment and at the lower end of which zone or cavity the at least one glass outlet orifice is located, the said lower cavity being intended to be filled with rotating molten glass.

9. Device according to claim 1, wherein at least one glass outlet orifice is located on or in the immediate vicinity of the rotation axis.

10. Device according to claim 1, wherein at least one glass outlet orifice is located at a non-zero distance from the rotation axis.

11. Device according claim 1, further, comprising an outer shell and an internal surface, in contact with the glass, between which is inserted a layer of insulating material resistant to high temperatures.

12. Device according to claim 12, wherein the outer shell is made of refractory steel.

13. Device according to claim 11 wherein the internal surface is formed by a platinum lining or by refractory ceramic covered with a thin coating of platinum.

14. Device according to claim 13, wherein the platinum lining or refractory ceramic covered with a thin coating of platinum is held mechanically in place by a vacuum created between the refractory steel shell and the platinum lining or refractory ceramic covered with a thin coating of platinum.

15. Device according to claim 14, wherein the seal between the platinum lining or refractory ceramic covered with a thin coating of platinum and the outer shell is produced by welding.

16. Device according to claim 11, wherein electrical resistors are placed in the insulation so as to be able to heat the device.

17. A process for refining and homogenizing glass using the device according to claim 1, comprising feeding molten glass into a receptacle of a device capable of rotating about an axis and conveying the said glass to a compartment of the said device, in which compartment the said glass is subjected to a subatmospheric pressure.

18. The process according to claim 17, wherein the molten glass feed takes place away from the rotation axis.

19. The process according to claim 17, wherein the molten glass is fed into the receptacle of the rotatable device at substantially atmospheric pressure.

20. The process according to claim 17, wherein the molten glass feed takes place at a height above the total height of the device.

21. The process according to claim 17, wherein the molten glass feed takes place at a height below the height of the compartment in which the glass is under vacuum.

22. The process according to claim 17, wherein the residence time of the glass in the device is less than ten minutes.

23. The process according to claim 17, wherein the residence time of the glass in the device is less than 5 minutes.

24. The process according to claim 17, wherein the residence time of the glass in the device is greater than 5 seconds.

25. The process according to claim 17, wherein the pressure within the vacuum compartment is less than 400 millibars.

26. The process according to claim 17, wherein the pressure within the vacuum compartment is less than 200 millibars.

27. The process according to claim 17, wherein the pressure within the vacuum compartment is between 50 and 150 millibars.

28. The process according to claim 17, wherein the glass after passing through the vacuum compartment is brought back to substantially atmospheric pressure by the effect of its own weight and then flows out of the rotatable device towards a forming step.

29. The process according to claim 17, wherein the glass is progressively heated to a uniform temperature corresponding to the forming temperature before being directly formed without passing through feeders of the forming means.

30. The process according to claim 17, wherein the rotation speed is between 150 and 500 revolutions per minute.

31. The process according to claim 17, wherein the rotation speed is between 160 and 180 revolutions per minute.

32. The process according to claim 17, wherein the mean temperature to which the glass is exposed is between 1 250 and 1 650° C.

33. The process according to claim 17, further comprising melting glass prior to refining and homogenizing the glass and forming a glass product after refining and homogenizing the glass.

34. The process according to claim 33, wherein the glass is melted at a temperature not more than 50° C. above the refining temperature.

35. The process according to claim 33, wherein the glass is melted by a process employing a furnace that includes at least one submerged burner.

36. The process according to claim 33, wherein the glass undergoes a forming step by floating on a bath of molten tin.

37. The process according to claim 33, wherein the glass then undergoes a forming step employing a float installation devoid of any points in which the molten float glass is stationary, the molten tin being injected into the installation so that it constitutes a receiving zone in which the molten glass is moving.

38. The process according to claim 33, wherein the process does not include a glass feeder.

39. The process according to claim 33, wherein the process does not include agitators or stirrers.

40. The process according to claim 17, wherein the glass contains no refining agents selected from the group consisting of sulphates, arsenic, antimony, chlorine and tin.

41. The process according to claim 17, wherein the glass has a composition comprising the following oxides in contents expressed as percentages by weight below:

| | |
|---|---|
| SiO₂ | 58-76% |
| B₂O₃ | 3-18% |
| Al₂O₃ | 4-22% |
| MgO | 0-8% |
| CaO | 1-12% |
| SrO | 0-5% |
| BaO | 0-3%. |

42. A process for manufacturing glass substrates for display systems comprising the refining and homogenizing process according to claim 17.

43. Glass substrate having a standard deviation of the refractive index of less than 5×10⁻⁵.

44. Glass substrate obtained by the float process having a microroughness of less than 20 nm.

45. The glass substrate according to claim 44, having a microroughness of less than 4 nm.

46. The glass substrate according to claim 44 wherein the substrate has not undergone a polishing step.

47. The glass substrate according to claim 43, having a composition comprising the following oxides in contents expressed as percentages by weight below:
SiO₂ 58-76%
B₂O₃ 3-18%
Al₂O₃ 4-22%
MgO 0-8%
CaO 1-12%
SrO 0-5%
BaO 0-3%.

48. The glass substrate according to claim 43, wherein the substrate does not comprise any refining agents selected from the group consisting of sulphates, arsenic, antimony, chlorine and tin.

49. A display system, filter or diffuser comprising the substrate of claim 43.

50. A plasma display, a liquid crystal display or an organicy light emitting diode comprising the substrate of claim 43.
